(19) United States
(12) Patent Application Publication
(10) Pub. No.: US 2026/0150127 A1
(43) Pub. Date: May 28, 2026

(54) SHORT CONTROL SIGNAL TRANSMISSIONS

(71) Applicant: InterDigital Patent Holdings, Inc., Wilmington, DE (US)

(72) Inventors: Aata El Hamss, Laval (CA); Tao Deng, New York, NY (US); Moon-il Lee, Melville, NY (US); Tuong Duc Hoang, Montreal (CA)

(73) Assignee: InterDigital Patent Holdings, Inc., Wilmington, DE (US)

(21) Appl. No.: 19/114,578

(22) PCT Filed: Sep. 28, 2023
(86) PCT No.: PCT/US2023/033927

§ 371 Date: Mar. 24, 2025

Related U.S. Application Data
(60) Provisional application No. 63/410,905, filed on Sep. 28, 2022.

(51) Int. Cl. H04W 74/0808; H04W 56/00

(52) U.S. Cl. CPC H04W 74/0808; H04W 56/001

(57) ABSTRACT

Described herein are systems, methods, and instrumentalities associated with short control signal transmissions. A wireless transmit/receive unit (WTRU) as described herein may receive configuration information from a network device, wherein the configuration information may indicate first short control signal transmission (SCSt) configuration information. The WTRU may determine whether a signal to be transmitted satisfies a condition, wherein the condition may be associated with at least a transmission priority associated with the signal. Based on a determination that the signal satisfies the condition, the WTRU may transmit the signal based on the first SCSt configuration information indicated by the configuration information. The WTRU may select the first SCSt configuration information over second SCSt configuration information also received by the WTRU. The WTRU may make the selection based on one or more characteristics of the signal to be transmitted.

### CROSS-REFERENCE TO RELATED APPLICATIONS

This application claims the benefit of Provisional U.S. patent application Ser. No. 63/410,905, filed Sep. 28, 2022, the disclosure of which is incorporated herein by reference in its entirety.

### BACKGROUND

In wireless communication, a clear channel access (CCA) may be obtained to occupy a channel (e.g., in an unlicensed band) for transmissions. If a transmission complies with certain requirements, the transmission may be performed without obtaining the CCA. The number and/or duration of such transmissions, however, may be limited.

### SUMMARY

Described herein are systems, methods, and instrumentalities associated with short control signal transmissions. A wireless transmit/receive unit (WTRU) as described herein may receive configuration information from a network device, wherein the configuration information may indicate first short control signal transmission (SCSt) configuration information. The WTRU may determine whether a signal to be transmitted satisfies a condition, wherein the condition may be associated with at least a transmission priority associated with the signal. Based on a determination that the signal satisfies the condition, the WTRU may transmit the signal based on the first SCSt configuration information indicated by the configuration information.

In examples, the condition described herein may be further associated with a cast type associated with the signal, a resource pool congestion status associated with the signal, a channel occupancy time associated with the signal, or a packet delay budget associated with the signal. In examples, the first SCSt configuration information described herein may indicate one or more of a first duty cycle, a first transmission duration, or a first transmission resource that may be used to perform an SCSt. In examples, the configuration information may further indicate second SCSt configuration information that may indicate one or more of a second duty cycle, a second transmission duration, or a second transmission resource, and the WTRU may select the first SCSt configuration information over the second SCSt configuration information for the transmission of the signal. The WTRU may select the first SCSt configuration information over the second SCSt configuration information based on one or more of a cast type associated with the signal, a resource pool congestion status associated with the signal, a channel occupancy time associated with the signal, or a packet delay budget associated with the signal.

In examples, the WTRU may transmit a message to another WTRU indicating that the signal has been transmitted based on the first SCSt configuration information. In examples, if the signal satisfies the condition, the WTRU may transmit the signal over a channel without obtaining a clear channel access to the channel, whereas, if the signal does not satisfy the condition, the WTRU may obtain a clear channel access to a channel and transmit the signal over the channel.

In examples, the signal transmitted using the first SCSt configuration may be associated with a physical sidelink feedback channel (PSFCH) transmission, a physical sidelink control channel (PSCCH) transmission, a sidelink synchronization signal block (S-SSB) transmission, or a sidelink channel state information (CSI) transmission.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of grouping sidelink resources by the time differences between the sidelink resources and an SCSt resource.

FIG. 3 is a diagram illustrating an example of a WTRU being configured with multiple SCSt configurations.

FIG. 4 is a flow diagram illustrating example operations that may be performed by a WTRU with respect to an SCSt.

### DETAILED DESCRIPITION

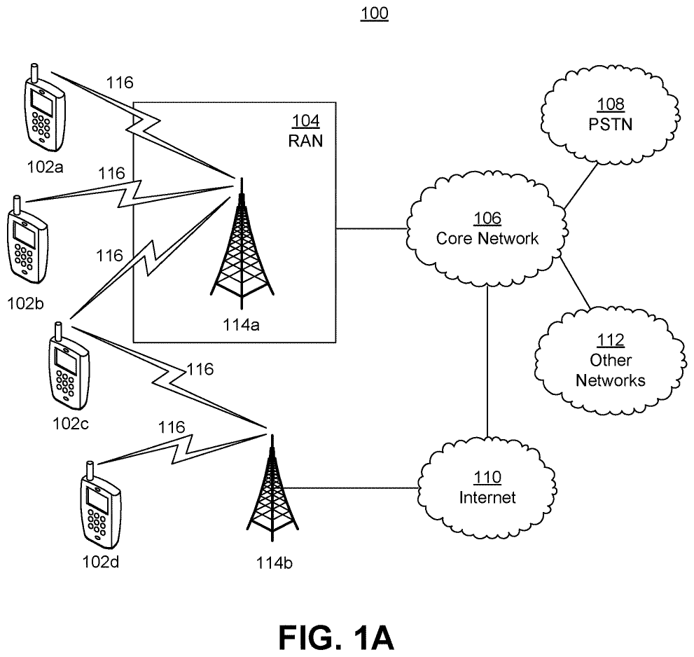

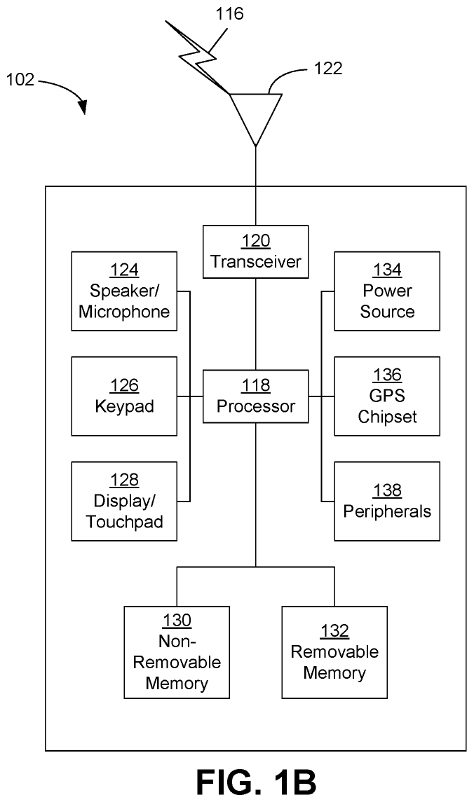

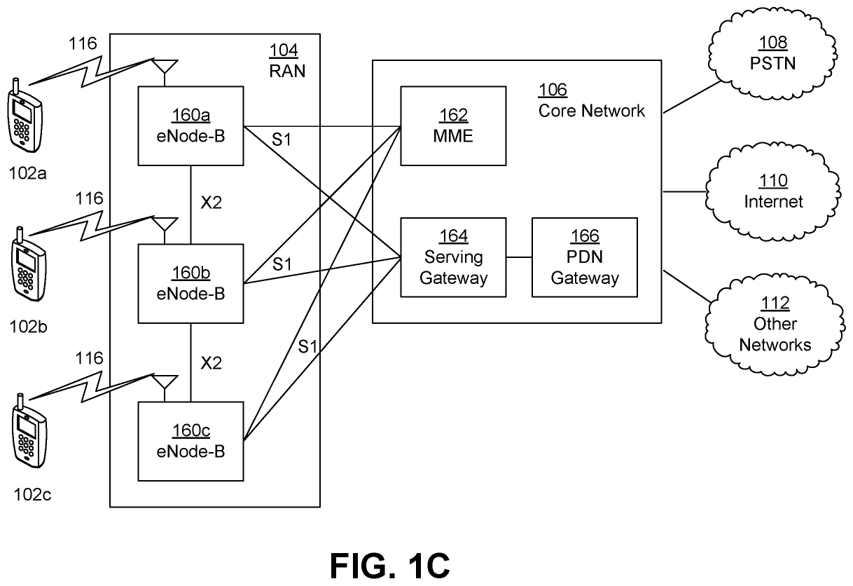

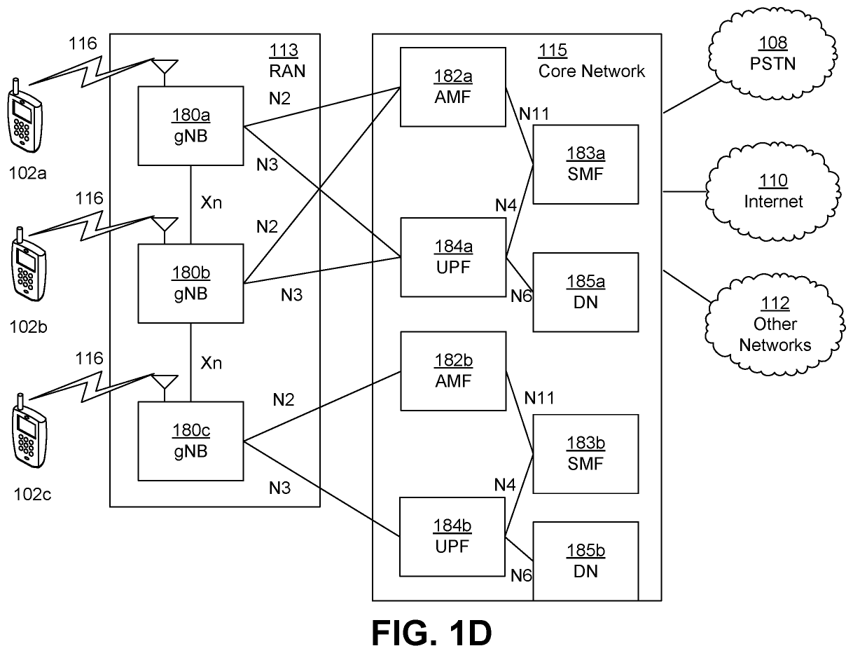

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (base station), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a base station).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like.

The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-WO switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUS 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108.

In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include base stations 180a, 180b, 180c, though it will be appreciated that the RAN 113 may include any number of base stations while remaining consistent with an embodiment. The base stations 180a, 180b, 180c may each include one or more transceivers for communicating with the WTRUs 102a, 102b, 102c over the air interface 116. In one embodiment, the base stations 180a, 180b, 180c may implement MIMO technology. For example, base stations 180a, 108b may utilize beamforming to transmit signals to and/or receive signals from the base stations 180a, 180b, 180c. Thus, the base station 180a, for example, may use multiple antennas to transmit wireless signals to, and/or receive wireless signals from, the WTRU 102a. In an embodiment, the base stations 180a, 180b, 180c may implement carrier aggregation technology. For example, the base station 180a may transmit multiple component carriers to the WTRU 102a (not shown). A subset of these component carriers may be on unlicensed spectrum while the remaining component carriers may be on licensed spectrum. In an embodiment, the base stations 180a, 180b, 180c may implement Coordinated Multi-Point (COMP) technology. For example, WTRU 102a may receive coordinated transmissions from base station 180a and base station 180b (and/or base station 180c).

The WTRUs 102a, 102b, 102c may communicate with base stations 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with base stations 180a, 180b, 180c using subframe or transmission time intervals (TTls) of various or scalable lengths (e.g., containing varying number of OFDM symbols and/or lasting varying lengths of absolute time).

The base stations 180a, 180b, 180c may be configured to communicate with the WTRUs 102a, 102b, 102c in a standalone configuration and/or a non-standalone configuration. In the standalone configuration, WTRUs 102a, 102b, 102c may communicate with base stations 180a, 180b, 180c without also accessing other RANs (e.g., such as eNode-Bs 160a, 160b, 160c). In the standalone configuration, WTRUs 102a, 102b, 102c may utilize one or more of base stations 180a, 180b, 180c as a mobility anchor point. In the standalone configuration, WTRUs 102a, 102b, 102c may communicate with base stations 180a, 180b, 180c using signals in an unlicensed band. In a non-standalone configuration WTRUs 102a, 102b, 102c may communicate with/connect to base stations 180a, 180b, 180c while also communicating with/connecting to another RAN such as eNode-Bs 160a, 160b, 160c. For example, WTRUs 102a, 102b, 102c may implement DC principles to communicate with one or more base stations 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and base stations 180a, 180b, 180c may provide additional coverage and/or throughput for servicing WTRUs 102a, 102b, 102c.

Each of the base stations 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the base stations 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the base stations 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the base stations 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QOS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, base station 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In wireless communication such as communication in an unlicensed spectrum, a clear channel access (CCA) may be performed to occupy a channel for transmission. If a transmission complies with one or more conditions, the transmission may be performed as a short control signaling transmission (SCSt) without obtaining a CCA. The number of short control signaling transmissions (e.g., in a 5-GHz band) performed within an observation period (e.g., 50 ms) by a communication device such as a WTRU may be limited (e.g., not exceeding 50). The total duration of short control signal transmissions within the observation period may also be limited (e.g., not exceeding 2500 μs). The transmissions that may be performed as an SCSt may include a control signal transmission such as a sidelink control signal transmission, a synchronization signal transmission, etc. In examples, an SCSt may be performed without sensing or determining whether a channel is available. In examples, an SCST may be performed after sensing a channel for a duration (e.g., a fixed duration).

Short control signaling may be supported in a wireless communication system such as a new radio (NR) system operating within an unlicensed spectrum. A discovery burst transmission (e.g., a synchronization signal block (SSB)) may satisfy a condition associated with an SCSt. Type 2A listen-before-talk (LBT) may be adopted for a discovery reference signal (DRS) transmission, for example, in a shared spectrum where one or more Type 2A channel access procedures may be applicable to (e.g., only to) the following transmissions performed by a network device (e.g., a base station such as an eNB or a gNB). These transmissions may include a discovery burst (e.g., not including PDSCH transmissions where the transmission duration is equal to or less than 1 ms). These transmissions may also include a discovery burst or a discovery burst multiplexed with non-unicast information, where the transmission duration is equal to or less than 1 ms, and/or the discovery burst duty cycle is equal to or less than 1/20. The transmissions may also include a transmission by a base station (e.g., an eNB and/or a gNB) that may follow a transmission by a WTRU (e.g., after a gap of 25 μs) in shared channel occupancy. Wireless communications may be performed using an unlicensed spectrum (e.g., above 52 GHz). A network device (e.g., a base station such as a gNB) and a WTRU may respectively transmit discovery bursts and/or physical random access channel (PRACH) messages in a random-access procedure.

As described herein, an SCSt may be transmitted without performing an LBT or a CCA. In some situations, however, it may not be possible to transmit a signal (e.g., a control signal) as an SCSt. For example, a transmitter may be configured to comply with regulations and not to transmit control signals as SCSts beyond a limit. Since the number of control signal transmissions may be more than the number of transmissions allowed in a time period or a duty cycle, the transmitter may not transmit the extra control signals as SCSts. In examples, a WTRU or a network device may be configured to (e.g., dynamically) switch between using an SCSt (e.g., not applying LBT before a transmission) and using regular LBT when performing control signal transmissions. A WTRU engaged in sidelink communication (e.g., using an unlicensed spectrum or band) may be configured to transmit an SCSt in manners that comply with regulatory requirements (e.g., without excessive use).

An SCSt may be used to perform a physical sidelink feedback channel (PSFCH) transmission, a physical sidelink control channel (PSCCH) transmission, a sidelink synchronization signal block SSB (S-SSB) transmission, a sidelink channel state information (CSI) related transmission, or other types of sidelink transmissions (e.g., in an unlicensed spectrum). A WTRU may be configured to perform any transmission that may qualify as (e.g., satisfy a condition associated with) an SCSt. For example, the WTRU may receive configuration information regarding the condition for determining whether a signal (e.g., a PSFCH and/or PSSCH transmission) qualifies as an SCSt (e.g., whether the PSFCH and/or PSSCH transmission may be transmitted as an SCSt). The WTRU may receive the configuration information (e.g., comprising one or more rules) regarding the condition as part of RRC configuration information or as part of dynamic configuration information (e.g., via a MAC CE or DCI). The WTRU may also be pre-configured with rules for determining whether a signal satisfies a condition for an SCSt transmission (e.g., the rules may be fixed for the WTRU based on standard specifications).

A WTRU may be configured with a time period and/or a maximum number of transmissions that the WTRU may perform within the time period (e.g., the WTRU may be configured not to exceed the maximum number of transmissions within the time period). The WTRU may start transmitting an SCSt within the configured time period and may start a timer (e.g., at the same time as or immediately after the SCSt transmission). The duration of the timer may correspond to the configured time period. Before the timer expires, the WTRU may not be allowed to transmit an SCSt if the maximum number of transmissions has been reached. If the configured maximum number of transmissions is greater than one within the configured time period, the WTRU may (e.g., jointly) use a counter and a timer. The WTRU may transmit more than one transmission and may increase the counter after a (e.g., each) transmission. When the counter value reaches the maximum number of transmissions within the configured time period, the WTRU may refrain from transmitting an SCSt until the timer expires.

A WTRU may receive SCSt configuration information that may indicate one or more of the following. The SCSt configuration information may indicate a cycle or a time period within which the number of SCSt transmissions may be kept below a threshold value. The SCSt configuration information may indicate a duty cycle associated with a maximum number of transmissions allowed within a configured cycle or time period. For example, a duty cycle of 3 may indicate that the WTRU may not transmit more than three SCSts within the configured cycle or period. The SCSt configuration information may indicate a maximum transmission duration of a transmission allowed in a duty cycle. For example, the WTRU may be configured with a maximum transmission duration of 1 ms for one or more transmissions (e.g., for each allowed transmission) within the duty cycle. The SCSt configuration information may indicate a resource configuration associated with an SCSt transmission. For instance, the WTRU may be configured with a resource pool and/or a resource set that may be used for SCSt transmissions, and the WTRU may use the resources in the resource pool/resource set for an SCSt transmission (e.g., when the WTRU is allowed to perform the SCSt transmission). The resource configuration may indicate multiple transmission opportunities for short control signaling within a duty cycle, and the WTRU may use one (e.g., at most one) of the opportunities within the duty cycle. In examples, the SCSt configuration information may not include a resource configuration and it may be up to the WTRU to select the resource for an SCSt transmission that may correspond to the SCSt configuration information. The SCSt configuration information may indicate a channel access type and/or an LBT type. For example, the SCSt configuration information may include an indication of a type of LBT that the WTRU may perform prior to transmitting an SCSt. For example, a first SCSt configuration may indicate that no LBT is required prior to transmitting an SCSt corresponding to the first SCSt configuration, and a second SCSt configuration may indicate that LBT type 2A may be performed prior to transmitting an SCSt corresponding to the second SCSt configuration. The first and second SCSt configurations (e.g., with different LBT requirements) may include different SCSt resource configurations.

The SCSt configuration information received by a WTRU may indicate a priority associated with the SCSt configuration. The priority may be used by the WTRU to select an SCSt configuration for an SCSt transmission. The SCSt configuration information may indicate a cast type (e.g., a broadcast, a group cast, etc.) of an SCSt to be transmitted based on the SCSt configuration information. The SCSt configuration information may indicate a multiplexing configuration for an SCSt to be transmitted based on the SCSt configuration information. For example, the SCSt configuration information may indicate whether an SCSt transmission may be multiplexed with other transmission. The multiplexing configuration may indicate which cast type may be multiplexed with the SCSt. For example, the SCSt configuration information may indicate that an SCSt may be multiplexed with a unicast transmission. In another example, the SCSt configuration information may indicate that an SCSt may be (e.g., only) multiplexed with a broadcast transmission. The SCSt configuration information may indicate a cyclic prefix extension (CPE) configuration, which may indicate a length of the CPE (e.g., in cases where the WTRU may use the CPE prior to transmitting an SCSt). Multiple CPE lengths may be configured for the WTRU for a (e.g., each) subcarrier spacing.

The WTRU may be configured with multiple SCSt configurations and may select one of the configurations to transmit a signal (e.g., control signal). For example, the WTRU may receive configuration information that may indicate first SCSt configuration information (e.g., one or more of a first duty cycle, a first transmission duration, or a first transmission resource associated with an SCSt). The configuration information may further indicate second SCSt configuration information (e.g., one or more of a second duty cycle, a second transmission duration, or a second transmission resource associated with an SCSt). If the WTRU determines to transmit a signal (e.g., a control signal) as an SCSt, the WTRU may determine which SCSt configuration information to use for the SCSt. For example, the WTRU may select the first SCSt configuration information over the second SCSt configuration for the SCSt. The WTRU may make the selection based on various characteristics of the signal to be transmitted, such as, e.g., a cast type of the signal, a resource pool congestion status associated with the signal, a channel occupancy time associated with the signal, and/or a packet delay budget associated with the signal.

After the WTRU selects an SCSt configuration, the WTRU may be configured not to use another (e.g., any other) SCSt configuration for a certain duration. For example, once the WTRU decides to use a first SCSt configuration, the WTRU may start a timer and wait until the timer expires before using another (e.g., any other) SCSt configuration (e.g., including the first SCSt configuration) for transmission.

The WTRU may receive an SCSt configuration that may not include resource configuration information. The WTRU may use a timer and/or a counter to comply with the SCSt configuration. For example, if the WTRU performs a transmission based on a certain SCSt configuration, the WTRU may use a timer and/or a counter to ensure that the WTRU does not transmit more than an allowed number of transmissions within a duty cycle associated with the SCSt configuration.

The WTRU may receive a WTRU-specific SCSt configuration and/or a group-specific SCSt configuration. If the WTRU receive a group-specific SCSt configuration, the WTRU may be configured to share SCSt usage with a group of WTRUs, for example, to avoid exceeding a limitation (e.g., a max number of transmissions per time period or duty cycle) associated with the SCSt configuration.

The WTRU may select an SCSt configuration for a control signal transmission. For example, the WTRU may determine whether the control signal transmission qualifies as (e.g., satisfies a condition associated with) an SCSt transmission and may select an SCSt configuration for transmitting the control signal. The control signal may be transmitted with or without being multiplexed with a non-control signal (e.g., a data signal). For example, the WTRU may transmit a PSCCH (e.g., a sidelink control transmission) multiplexed with a PSSCH (e.g., a sidelink data transmission), or the WTRU may transmit an SL-SSB multiplexed with a PSSCH transmission. The WTRU may determine whether the control signal transmission qualifies as an SCSt based on one or more of the following conditions. The WTRU may determine that the control signal transmission qualifies as an SCSt if the transmission duration is less than a configured threshold value. For example, a PSFCH transmission may qualify as an SCSt transmission if the duration of the PSFCH transmission is less than a specific number of (e.g., two) symbols. The WTRU may determine that the control signal transmission qualifies as an SCSt based on a transmission type related to the control signal. For example, a PSSCH for scheduling a broadcast transmission may qualify as an SCSt. The WTRU may determine that the control signal transmission qualifies as an SCSt based on a priority associated with the control signal transmission (e.g., based on a per-packet priority). For example, a control signal that carries high priority information (e.g., scheduling information) may qualify as an SCSt. The WTRU may determine that the control signal transmission qualifies as an SCSt based on information carried by the control signal transmission. For example, a control signal that carries a pre-emption indication may qualify as an SCSt. The WTRU may determine that the control signal transmission qualifies as an SCSt based on a packet delay budget (PDB) associated with the control signal transmission.

The WTRU may (e.g., as a first step) determine whether a control signal qualifies as an SCSt and may select (e.g., as a second step) an SCSt configuration to apply to the control signal transmission. The selection may be conditioned on one or more of the followings. For example, a transmitter (Tx) WTRU may determine whether a control signal transmission qualifies as an SCSt transmission (e.g., based on the conditions described above), and may indicate to a receiver (Rx) WTRU whether the control signal transmission qualifies as the SCSt transmission. The Tx WTRU may indicate to the Rx WTRU SCSt configuration(s) that the Rx WTRU may selected from and/or an SCSt transmission opportunity (e.g., SCSt resources) that the Rx WTRU may use. The Tx WTRU may use a bit field in sideline control information (SCI) to provide the SCSt configuration(s) and/or the SCSt transmission resource(s) to the Rx WTRU.

The WTRU may select an SCSt configuration to use for a control signal transmission (e.g., if the WTRU determines that the control signal transmission qualifies as an SCSt) based on one or more of the following. The WTRU may select the SCSt configuration for the control signal transmission based on a cast type associated with the control signal transmission. For example, if the WTRU is to transmit a control signal related to a broadcast transmission, the WTRU may select an SCSt configuration associated with broadcast transmissions. The WTRU may select the SCSt configuration for the control signal transmission based on a priority associated with the control signal transmission. For example, if the WTRU is to transmit a high priority control signal (e.g., carrying scheduling information), the WTRU may select an SCSt configuration associated with high priority transmissions. The WTRU may select the SCSt configuration for the control signal transmission based on a resource pool congestion status/condition (e.g., which may be determined based on channel busy ratio (CBR) measurements). For example, the WTRU may select, for the control signal transmission, an SCSt configuration with a resource configuration associated with a less congested resource pool. For example, the WTRU may measure the CBR of one or more resource pools (e.g., of each resource pool) and may select the resource pool with a small CBR. The WTRU may select the SCSt configuration for the control signal transmission based on an ongoing channel occupancy time (COT) and/or an initiation of a COT. The WTRU may determine not to use an SCSt configuration for the control signal transmission if the WTRU has already initiated a COT or may initiate a COT in the next X ms (e.g., the value of X may depend on the PDB of the data transmission(s) related to the control signal). The WTRU may select the SCSt configuration for the control signal transmission based on the availability (e.g., in terms of time) of SCSt resources and/or a PDB. For example, the WTRU may select an SCSt configuration with an SCSt resource availability that satisfies the PDB for related transmission(s). The WTRU may select the SCSt configuration for the control signal transmission based on whether another transmission is to be multiplexed with the control signal transmission. For example, if the WTRU is to multiplex a unicast transmission with the control signal, the WTRU may select an SCSt configuration under which multiplexing with unicast may be allowed. If multiple SCSt configurations (e.g., multiple qualified configurations) may be used for a control signal transmission, the WTRU may randomly select an SCSt configuration from the qualified configurations.

An SCSt transmission may be performed before an SCSt resource configuration is received. For example, the WTRU may be configured to transmit before the next transmission opportunity performed by an SCSt configuration if waiting until the next opportunity may not satisfy the PDB for a related sidelink data transmission. For example, the WTRU may determine that a PSFCH transmission qualifies as an SCSt and may select a SCSt transmission configuration to use for the PSFCH transmission. The first available SCSt resource within the selected SCSt transmission configuration may lead to the WTRU exceeding the PDB associated with data transmission related to the PSFCH transmission. In such a situation, the WTRU may transmit before the next opportunity, for example, using an LBT configuration associated with the selected SCSt transmission configuration. The WTRU may start a timer when transmitting before the first available transmission opportunity and may not transmit an (e.g., any) SCSt before the timer expires.

SCSt configuration selection and sidelink resource selection may be performed jointly. For example, the WTRU may be configured to jointly select an SCSt configuration and sidelink resources for data transmission during sidelink resource sensing and/or a sidelink resource selection procedure. For example, after sensing a channel during a sensing window, the WTRU may group sidelink resources based on the time difference between a sidelink data resource and an SCSt resource within an SCSt configuration. The WTRU may group sensed sidelink resources into a first group if the time difference between the resources and the next SCSt transmission opportunity is less than a first threshold value. The WTRU may group sensed sidelink resources into a second group if the respective time locations of the resources are after the time location of a first SCSt resource and the time differences between the time locations of the resources and a second SCSt resource is less than a second threshold value. The WTRU may select the group that satisfies a PDB if the corresponding SCSt resources are to be used (e.g., if a PSFCH is to be sent). For example, for a short PDB, the WTRU may select one or more sidelink resources from the first group and, for a longer PDB, the WTRU may select one or more sidelink resources from the second group.

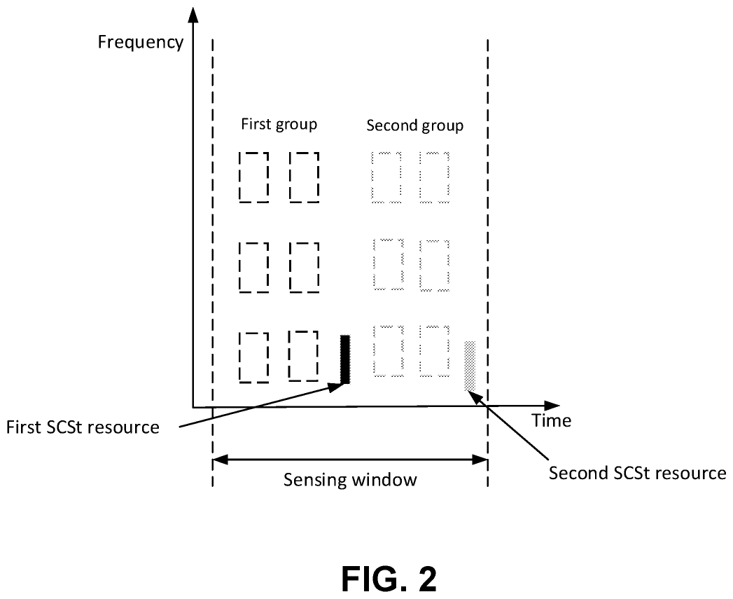

FIG. 2 illustrates an example of grouping sensed sidelink resources by the time differences between the sensed sidelink resources and an SCSt resource.

The timing relationship between a PSSCH transmission and a PSFCH transmission may depend on the periodicity of an SCSt configuration. A WTRU may be configured to determine the PSFCH transmission time relative to the PSSCH transmission time based on an available SCSt resource configuration. For example, the WTRU may select the PSFCH transmission time that is the same as the SCSt transmission time within a selected SCSt configuration.

Multiple WTRUs may transmit using the same SCSt configuration. A WTRU may experience contiguous LBT failures when attempting to access a channel for performing a control signal transmission. In some examples, the WTRU may be configured to increase the priority of the control signal transmission (e.g., increase the priority of a PSFCH transmission) after a (e.g., each) failure of an LBT. If the priority of the control signal is increased, the WTRU may use an SCSt configuration or opportunity to transmit the PSFCH. For example, the WTRU may have a PSFCH transmission with a priority p3 (e.g., among multiple priorities p1, p2, p3 and p4, where p1 may be the highest priority and p4 may be the lowest priority). The WTRU may attempt to transmit the PSFCH in a first occasion and may fail due to an LBT. The WTRU may increase the priority of the PSFCH to p2 and attempt to transmit the PSFCH in a second occasion. The WTRU may fail again due to another LBT failure and may increase the PSFCH priority to p1. After the priority of the PSFCH reaches p1, the WTRU may use an SCSt configuration or opportunity to transmit the PSFCH.

An SCSt resource may overlap with a channel occupancy time (COT) (e.g., an initiated COT). A WTRU may determine that the COT may be initiated by another WTRU, where the time domain resource of the COT may overlap with an SCSt resource (e.g., the WTRU may determine that the COT is initiated based on a transmitted SCI indicating the COT is initiated by other WTRU(s) or based on an indication received from a network device such as a gNB). In such a case, the WTRU may be configured to use LBT type 2A or type 2B (e.g., sensing a channel for a certain duration prior to transmitting on an SCSt resource) even if the SCSt configuration includes no LBT prior to the transmission on an SCSt resource. For example, the WTRU may be configured with and/or may select an SCSt configuration that may include a configured SCSt resource without LBT. If the WTRU determines that a channel occupancy time is initiated (e.g., by decoding an SCI from other WTUR(s) or by receiving an indication from a network device such as a gNB), the WTRU may use LBT type 2A prior to transmitting on an SCSt resource. The WTRU may be configured to use LBT type 2A prior to transmitting the SCSt as part of the SCSt configuration. The WTRU may be configured to use LBT type 2A in case of congestion (e.g., which may be determined based on measurements of a resource pool).

A WTRU may be configured to adopt or apply a cyclic prefix extension (CPE) before transmitting on an SCSt resource. A length of the CPE may depend on a priority associated with the control signal transmission using the SCSt resource. The length of the CPE may be part of the SCSt configuration and/or may depend on the subcarrier spacing used for sidelink transmissions. The WTRU may be configured to select the CPE from a pool or set of CPE values. The WTRU may be configured to randomly select the CPE from the pool.

A WTRU may be configured to indicate a SCSt or the usage of a SCSt configuration for the SCSt to one or more other WTRU(s). For example, the WTRU may be configured to transmit sidelink control information (SCI) indicating whether the WTRU has transmitted an SCSt corresponding to an SCSt configuration. The WTRU may indicate in the SCI the number of used opportunities associated with the SCSt configuration. The WTRU may transmit the indication to a group of WTRUs, for example, using a group-cast ID associated with the SCSt configuration (e.g., if the WTRU is configured with a group-specific SCSt configuration). The WTRU may indicate in an SSL-SSB whether a transmitted SCSt corresponds to an SCSt configuration. For example, the WTRU may transmit the indication in a physical sidelink broadcast channel that may be multiplexed with an SL-SSB.

A WTRU may be configured with one or more SCSt configurations, where a (e.g., each) SCSt configuration may include a duty cycle and/or a transmission time period, a maximum transmission duration, a set of allowed transmission durations, a resource configuration (e.g., including a resource pool configuration), and/or an LBT type. The WTRU may determine whether to use one of the SCSt configurations for a control signal transmission (e.g., a PSFCH and/or PSCCH transmission) based on a transmission type of the control signal, a cast type of the control signal, a priority of the control signal, a resource pool congestion status associated with the control signal, an ongoing COT associated with the control signal, the availability of an option for falling back to a regular channel access mechanism for the control signal, etc. The WTRU may indicate to other WTRUs (e.g., WTRUs configured to communicate using an SL unlicensed spectrum) whether or not an SCSt transmission opportunity was used.

The WTRU may determine whether a control signal transmission (e.g., a PSFCH or PSSCH transmission) may qualifies as an SCSt and/or which SCSt configuration may be use for the SCSt based on one or more of a transmission type related to the control signal transmission (e.g., whether a PSSCH transmission is used to schedule a high priority transmission or to indicate a pre-emption indication), the priority of the control signal transmission, a cast type associated with the control signal transmission, the congestion status of a resource pool associated with the control signal transmission (e.g., based on CBR measurements), an on-going COT, the initiation of a new COT, the availability (e.g., in terms of time) of SCSt resources and/or PDB, etc.

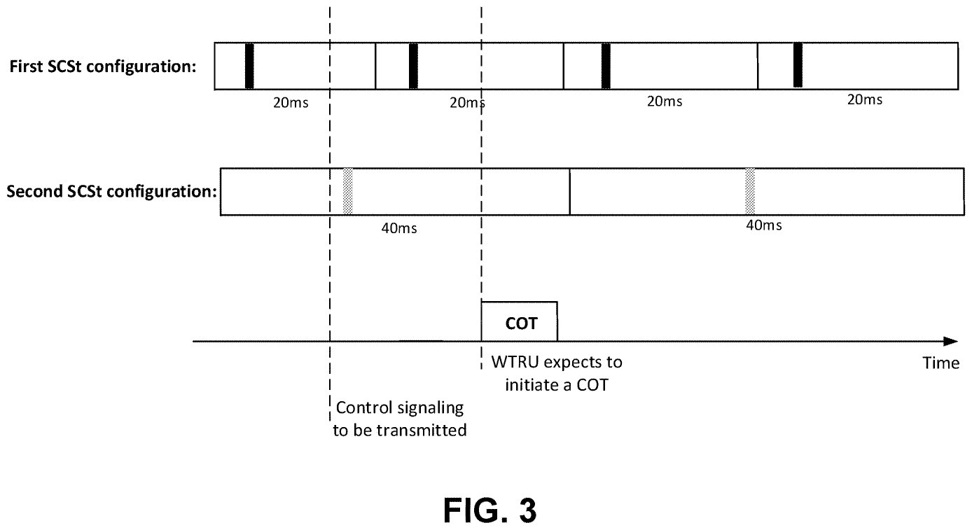

FIG. 3 illustrates an example where a WTRU may be configured with multiple (e.g., two) SCSt configurations and may start a COT after the transmission time of a control signal.

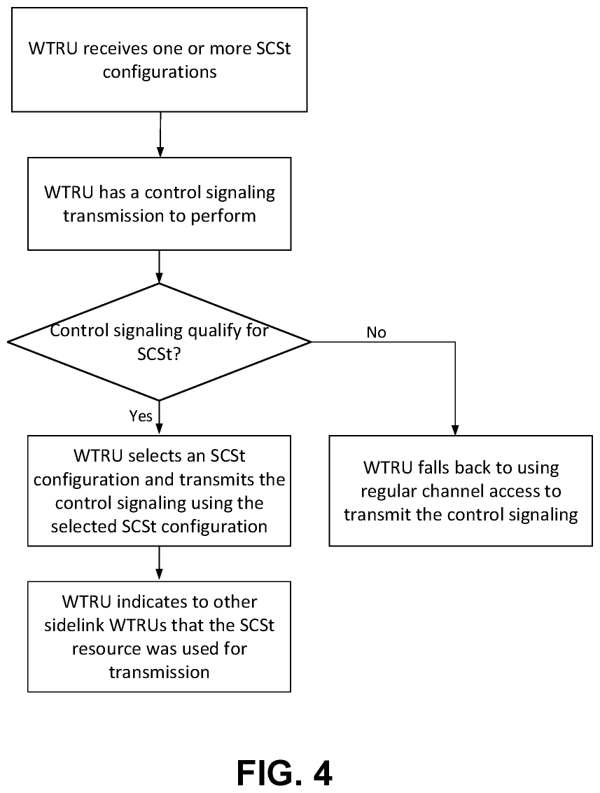

FIG. 4 illustrates example operations that may be performed by a WTRU to apply (e.g., use) an SCSt configuration. As shown in FIG. 4, the WTRU may fall back to using a regular channel access mechanism if a control signal does not qualify as an SCSt (or if the WTRU does not find an SCSt configuration that may be used for the intended control signal transmission). In such a situation, the WTRU may fall back to obtaining a clear channel access to a channel and transmitting the control signal over that channel. Also as shown in FIG. 4, the WTRU may indicate (e.g., via SCI) to other WTRUs whether a SCSt configuration and/or an SCSt resource (e.g., indicated by the SCSt configuration or determined by the WTRU autonomously) was used for a control signal transmission. For example, if a WTRU transmits a SCSt based on certain SCSt configuration information received from a network device, the WTRU may transmit a message to another WTRU, wherein the message may include an indication that the SCSt has been transmitted based on the SCSt configuration information.

Although features and elements described above are described in particular combinations, each feature or element may be used alone without the other features and elements of the preferred embodiments, or in various combinations with or without other features and elements. Although the implementations described herein may consider 3GPP specific protocols, it is understood that the implementations described herein are not restricted to this scenario and may be applicable to other wireless systems. For example, although the solutions described herein consider LTE, LTE-A, new radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU), comprising:
a processor configured to:
receive first short control signal transmission (SCSt) configuration information;
determine whether to transmit a sidelink signal as an SCSt, wherein the determination is made based at least on a transmission priority of the sidelink signal and a congestion status of a sidelink resource pool associated with the sidelink signal; and
if the determination is to transmit the sidelink signal as the SCSt, transmit the sidelink signal based on the first SCSt configuration information.

17. The WTRU of claim 16, wherein the determination of whether to transmit the sidelink signal as the SCSt is made further based on a cast type associated with the sidelink signal, a channel occupancy time associated with the sidelink signal, or a packet delay budget associated with the sidelink signal.

18. The WTRU of claim 16, wherein the first SCSt configuration information indicates one or more of a first duty cycle, a first transmission duration, or a first transmission resource.

19. The WTRU of claim 18, wherein the processor is further configured to receive second SCSt configuration information that indicates one or more of a second duty cycle, a second transmission duration, or a second transmission resource, and wherein the processor being configured to transmit the sidelink signal based on the first SCSt configuration information comprises the processor being configured to select the first SCSt configuration information over the second SCSt configuration information for the transmission of the sidelink signal.

20. The WTRU of claim 19, wherein the processor is configured to select the first SCSt configuration information over the second SCSt configuration information based on one or more of a cast type associated with the sidelink signal, a channel occupancy time associated with the sidelink signal, or a packet delay budget associated with the sidelink signal.

21. The WTRU of claim 16, wherein the processor is further configured to transmit a message to another WTRU that indicates that the sidelink signal has been transmitted based on the first SCSt configuration information.

22. The WTRU of claim 16, wherein the processor is configured to transmit the sidelink signal over a channel without obtaining a clear channel access to the channel prior to the transmission.

23. The WTRU of claim 22, wherein, if the determination is not to transmit the sidelink signal as the SCSt, the processor is further configured to obtain the clear channel access to the channel prior to transmitting the sidelink signal over the channel.

24. The WTRU of claim 16, wherein the sidelink signal includes a physical sidelink feedback channel (PSFCH) transmission, a physical sidelink control channel (PSCCH) transmission, a sidelink synchronization signal block (S-SSB) transmission, or a sidelink channel state information (CSI) transmission.

25. The WTRU of claim 16, wherein the transmission priority of the sidelink signal is determined based on the content of the sidelink signal and wherein the congestion status of the sidelink resource pool is determined based on a channel busy ratio of the sidelink resource pool.

26. A method implemented by a wireless transmit/receive unit (WTRU), the method comprising:
receiving first short control signal transmission (SCSt) configuration information;
determining whether to transmit a sidelink signal as an SCSt, wherein the determination is made based at least on a transmission priority of the sidelink signal and a congestion status of a sidelink resource pool associated with the sidelink signal; and
if the determination is to transmit the sidelink signal as the SCSt, transmitting the sidelink signal based on the first SCSt configuration information.

27. The method of claim 26, wherein the determination of whether to transmit the sidelink signal as the SCSt is made further based on a cast type associated with the sidelink signal, a channel occupancy time associated with the sidelink signal, or a packet delay budget associated with the sidelink signal.

28. The method of claim 26, wherein the first SCSt configuration information indicates one or more of a first duty cycle, a first transmission duration, or a first transmission resource.

29. The method of claim 28, further comprising receiving second SCSt configuration information that indicates one or more of a second duty cycle, a second transmission duration, or a second transmission resource, wherein transmitting the sidelink signal based on the first SCSt configuration information comprises selecting the first SCSt configuration information over the second SCSt configuration information for the transmission of the sidelink signal.

30. The method of claim 29, wherein the first SCSt configuration information is selected over the second SCSt configuration information based on one or more of a cast type associated with the sidelink signal, a channel occupancy time associated with the sidelink signal, or a packet delay budget associated with the sidelink signal.

31. The method of claim 26, further comprising transmitting a message to another WTRU indicating that the sidelink signal has been transmitted based on the first SCSt configuration information.

32. The method of claim 26, wherein the sidelink signal includes a physical sidelink feedback channel (PSFCH) transmission, a physical sidelink control channel (PSCCH) transmission, a sidelink synchronization signal block (S-SSB) transmission, or a sidelink channel state information (CSI) transmission.

33. The method of claim 32, wherein the sidelink signal is transmitted as the SCSt over a channel without obtaining a clear channel access to the channel prior to the transmission.

34. The method of claim 33, wherein, if the determination is not to transmit the sidelink signal as the SCSt, the method further comprises obtaining the clear channel access to the channel prior to transmitting the sidelink signal over the channel.

35. The method of claim 26, wherein the transmission priority of the sidelink signal is determined based on the content of the sidelink signal and wherein the congestion status of the sidelink resource pool is determined based on a channel busy ratio of the sidelink resource pool.
